(19) United States
(12) Patent Application Publication
(10) Pub. No.: US 2006/0050021 A1
(43) Pub. Date: Mar. 9, 2006

(54) Plasma display apparatus and driving method thereof

(76) Inventor: Jeong Pil Choi, Suwon-si (KR)

Correspondence Address: MCKENNA LONG & ALDRIDGE LLP;Song K. Jung, 1900 K Street, N.W., Washington, DC, 20006, US

(21) Appl. No.: 11/218,565

(22) Filed: Sep. 6, 2005

(30) Foreign Application Priority Data
Sep. 7, 2004 (KR) 10-2004-0071471

(51) Int. Cl. G09G 3/28

(52) U.S. Cl. 345/60

(57) ABSTRACT

The present invention relates to a plasma display apparatus including an energy recovery circuit capable of maximizing driving efficiency, and driving method thereof. The plasma display apparatus of the present invention includes a plasma display panel having an electrode, an energy supply and recovery unit for dividing a source voltage source to supply the energy of a first voltage higher than a reference voltage and to supply the energy of a second voltage lower than the reference voltage, a path select controller for establishing a path so that the energy of the first voltage is supplied to the electrode through resonance and establishing a path so that the energy of the second voltage is recovered from the electrode through resonance, and a voltage sustain unit for applying a third voltage to the electrode after the energy of the first voltage has been supplied to the electrode through resonance and applying a fourth voltage to the electrode after the energy of the second voltage has been recovered from the electrode through resonance. According to the present invention, the energy supply and recovery unit supplies energy greater than the reference voltage and recovers energy lower than the reference voltage. Accordingly, driving efficiency can be improved.

### CROSS-REFERENCES TO RELATED APPLICATIONS

This Nonprovisional application claims priority under 35 U.S.C. § 119(a) on Patent Application No. 2004-0071471 filed in Korea on Sep. 7, 2004 the entire contents of which are hereby incorporated by reference.

### BACKGROUND OF THE INVENTION

1. Field of the Invention

The present invention relates to a plasma display apparatus and driving method thereof, and more particularly, to a plasma display apparatus having an energy recovery circuit and driving method thereof.

2. Background of the Related Art

Generally, a plasma display panel is adapted to display images including characters or graphics by emitting phosphors with ultraviolet ray of 147 nm generated during the discharge of an inert mixed gas of He+Xe or Ne+Xe.

FIG. 1 is a perspective view illustrating the structure of a general three-electrode AC surface discharge type plasma display panel. As shown in FIG. 1, the plasma display panel includes a scan electrode 12A and a sustain electrode 12B formed on an upper substrate 10, and an address electrode 20 formed on a lower substrate 18.

Each of the scan and sustain electrode 12A and 12B includes a transparent electrode and a bus electrode. The transparent electrode is formed using Indium Tin Oxide (ITO). The bus electrode is formed using metal that can reduce resistance.

An upper dielectric layer 14 and a protection film 16 are laminated on the upper substrate 10 having the scan electrodes 12A and the sustain electrode 12B formed thereon.

On the upper dielectric layer 14 are accumulated wall charges generated during the discharge of plasma. The protection film 16 serves to prevent damage to the upper dielectric layer 14 due to sputtering generated during the discharge of plasma and also enhance emission efficiency of secondary electrons. The protection film 16 is generally formed using magnesium oxide (MgO).

Meanwhile, a lower dielectric layer 22 and barrier ribs 24 are formed on the lower substrate 18 having an address electrode 22 formed therein. A phosphor layer 26 is coated on surfaces of the lower dielectric layer 22 and the barrier ribs 24.

The address electrode 20 is formed in a direction where it crosses the scan electrodes 12A and the sustain electrode 12B. The barrier ribs 24 are formed parallel to the address electrode 22, and serve to prevent UV ray and a visible ray generated by discharging from leaking to neighboring discharge cells.

The phosphor layer 26 is excited by UV ray generated during the discharge of plasma to generate any of red, green and blue visible rays. An inert mixed gas for discharging, such as He+Xe or Ne+Xe, is injected into discharge spaces of discharge cells, which are defined between the upper/lower substrates 10, 18 and the barrier ribs 24.

FIG. 2 is a circuit diagram of the energy recovery circuit of the conventional plasma display apparatus. FIG. 3 shows a waveform of the voltage of the current formed by the ideal operation of the energy recovery circuit of the conventional plasma display apparatus.

The conventional energy recovery circuit operates in four steps in order to apply a sustain pulse that sustains discharging of the panel.

In step 1, if a first switch S1 is turned on and the remaining switches are turned off, energy charged in a capacitor Css is supplied to the panel through resonance with an inductor L. Accordingly, as shown in FIG. 3, the current IL of the inductor L forms a positive sine wave and the voltage of the panel rises up to a sustain voltage (Vs).

In step 2, the first switch S1 keeps turned on and the third switch S3 is turned on. Accordingly, the panel is supplied with the sustain voltage (Vs). At this time, the voltage of the panel is kept to the sustain voltage (Vs).

In step 3, the second switch S2 is turned on and the remaining switches are turned off. Accordingly, energy that has been supplied to the panel is recovered to the capacitor Css through resonance with the inductor L. Therefore, as shown in FIG. 3, the current IL of the inductor L forms a negative sine wage and the voltage of the panel falls from the sustain voltage (Vs) to a ground level.

In step 4, the fourth switch S4 is turned of and the voltage of the ground level is applied to the panel. Accordingly, as shown in FIG. 3, the panel is kept to the ground level.

At this time, the capacitor Css supplies and recovers energy corresponding to 0.5 times the sustain voltage (Vs). Since the supply and recovery of energy are performed through resonance with the inductor L, energy supplied by the capacitor Css is energy corresponding to an intermediate value of the sustain voltage (Vs) and the ground level.

If the conventional energy recovery circuit operates ideally, the voltage of the panel rises from the ground level (0V) to the sustain voltage (Vs) and then falls from the sustain voltage (Vs) to the ground level (0V). In this case, the efficiency of the energy recovery circuit is 100%. However, the actual efficiency of the energy recovery circuit is less than 100%.

FIG. 4 shows a waveform formed by an ideal operation of the conventional energy recovery circuit. As shown in FIG. 4, the voltage of the panel does not rises up to the sustain voltage (Vs), but rises only up to a voltage as low as Vd. In the same manner, the voltage of the panel does not fall up to the ground level, but rises only up to a voltage as high as Vd′.

The reason why such error Vd, Vd′ is generated is that leakage power consumption, etc. is generated in mounted driving circuits and circuit components. Therefore, enhancing the efficiency of the energy recovery circuit means minimizing Vd.

### SUMMARY OF THE INVENTION

Accordingly, the present invention has been made in view of the above problems, and it is an object of the present invention to provide a plasma display apparatus including an energy recovery circuit capable of maximizing driving efficiency, and driving method thereof.

To achieve the above object, a plasma display apparatus according to the present invention includes a plasma display panel having an electrode, an energy supply and recovery unit for dividing a source voltage source to supply the energy of a first voltage higher than a reference voltage and to supply the energy of a second voltage lower than the reference voltage, a path select controller for establishing a path so that the energy of the first voltage is supplied to the electrode through resonance and establishing a path so that the energy of the second voltage is recovered from the electrode through resonance, and a voltage sustain unit for applying a third voltage to the electrode after the energy of the first voltage has been supplied to the electrode through resonance and applying a fourth voltage to the electrode after the energy of the second voltage has been recovered from the electrode through resonance.

The energy supply and recovery unit may have three or more capacitors connected with one another in series, for dividing the source voltage source to form the first voltage and the second voltage.

The energy supply and recovery unit may have a first capacitor, a second capacitor and a third capacitor that are connected with one another in series. At this time, the first capacitor can be connected at one end to the source voltage source, the second capacitor can be connected at one end to the other end of the first capacitor, and the third capacitor can be connected at one end to the other end of the second capacitor. Further, the first voltage can be formed at the connection node of the first capacitor and the second capacitor, and the second voltage can be formed at the connection node of the second capacitor and the third capacitor.

Each of the three or more capacitors may have the same capacitance.

The reference voltage may be a voltage corresponding to 0.5 times the third voltage.

A voltage of the source voltage source and the third voltage may be the same.

The fourth voltage may be a voltage of the ground level.

The path select controller may include a first switch for forming the supply path of energy corresponding to the first voltage, a second switch for forming the supply path of energy corresponding to the second voltage, and an inductor for supplying energy corresponding to the first voltage, which is applied through the first switch that is turned on, to the electrode through resonance and recovering energy corresponding to the second voltage from the second switch that is turned on by way of resonance.

A plasma display apparatus according to the present invention includes an energy supply and recovery unit including three or more capacitors connected with one another in series, for dividing a source voltage source, wherein the energy supply and recovery unit supplies the energy of a first voltage higher than a reference voltage and recovers the energy of a second voltage lower than the reference voltage; a path select controller for establishing a path so that the energy of the first voltage is supplied to the electrode through resonance and establishing a path so that the energy of the second voltage is recovered from the electrode through resonance; and a voltage sustain unit for applying a third voltage to the electrode after the energy of the first voltage has been supplied to the electrode through resonance and applying a fourth voltage to the electrode after the energy of the second voltage has been recovered from the electrode through resonance.

The energy supply and recovery unit may include three or more capacitors connected with one another in series, for dividing the source voltage source to form the first voltage and the second voltage.

The energy supply and recovery unit may include a first capacitor, a second capacitor and a third capacitor that are connected with one another in series. In this case, the first capacitor may be connected at one end to the source voltage source, the second capacitor may be connected at one end to the other end of the first capacitor, and the third capacitor may be connected at one end to the other end of the second capacitor. Furthermore, the first voltage may be formed at the connection node of the first capacitor and the second capacitor, and the second voltage may be formed at the connection node of the second capacitor and the third capacitor.

Each of the three or more capacitors may have the same capacitance.

The reference voltage may be a voltage corresponding to 0.5 times the third voltage.

A voltage of the source voltage source and the third voltage may be the same.

The fourth voltage may be a voltage of the ground level.

A driving method of a plasma display panel including an electrode according to the present invention includes the steps of supplying the energy of a first voltage higher than a reference voltage to the electrode through resonance, applying a third voltage to the electrode, recovering the energy of the second voltage lower than the reference voltage from the electrode to the energy supply and recovery unit through resonance, and applying a fourth voltage to the electrode.

The reference voltage may be a voltage corresponding to 0.5 times the third voltage.

A voltage of the source voltage source and the third voltage may have the same.

The fourth voltage may be a voltage of the ground level.

### BRIEF DESCRIPTION OF THE DRAWINGS

Further objects and advantages of the invention can be more fully understood from the following detailed description taken in conjunction with the accompanying drawings in which:

FIG. 1 is a perspective view illustrating the structure of a general three-electrode AC surface discharge type plasma display panel;

FIG. 2 is a circuit diagram of the energy recovery circuit of the conventional plasma display apparatus;

FIG. 3 shows a waveform of the voltage of the current formed by the ideal operation of the energy recovery circuit of the conventional plasma display apparatus;

FIG. 4 shows a waveform formed by the ideal operation of the conventional energy recovery circuit;

FIG. 5 is a circuit diagram showing the construction of the plasma display apparatus according to the present invention;

FIG. 6 shows another embodiment of an energy supply and recovery unit according to the present invention;

FIG. 7 shows a driving waveform depending on the driving method of the plasma display apparatus according to a first embodiment of the present invention; and

FIG. 8 shows a driving waveform depending on the driving method of the plasma display apparatus according to a second embodiment of the present invention.

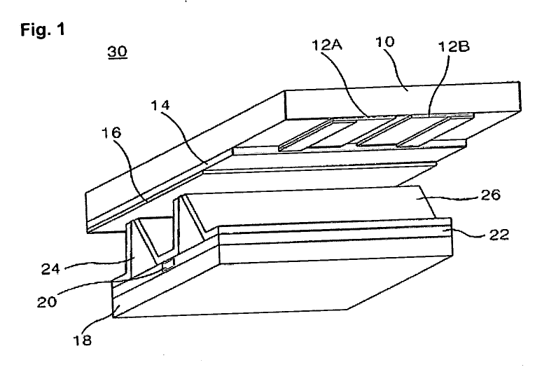

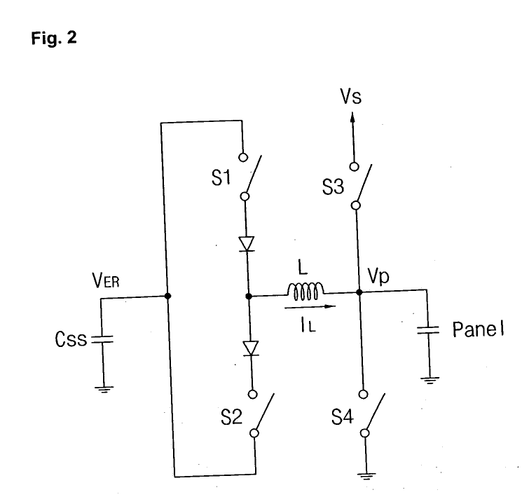

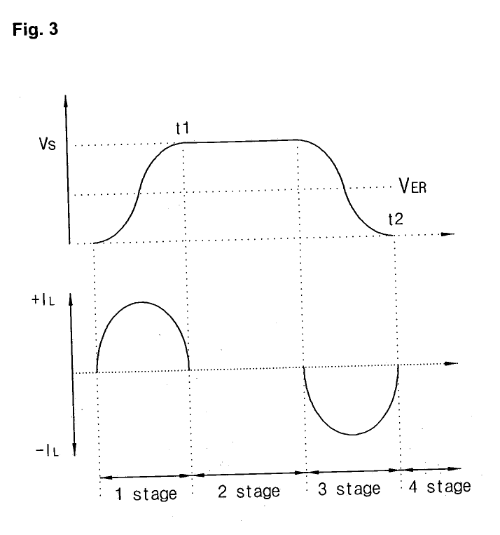

### DETAILED DESCRIPTION OF THE PREFERRED EMBODIMENT

The present invention will now be described in detail in connection with preferred embodiments with reference to the accompanying drawings.

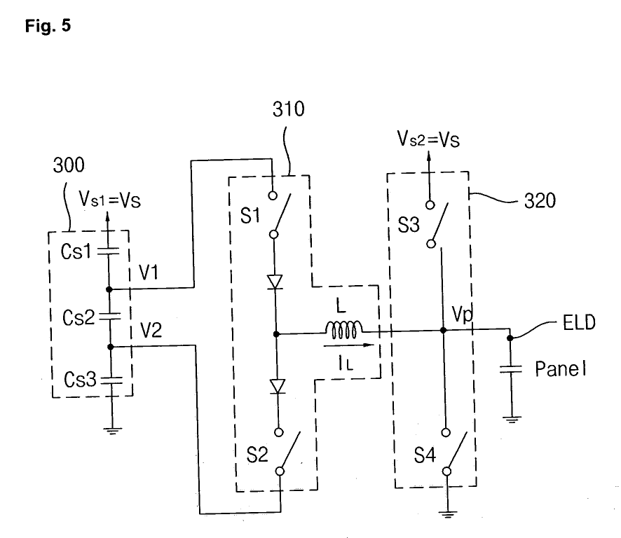

FIG. 5 is a circuit diagram showing the construction of the plasma display apparatus according to the present invention. As shown in FIG. 5, the plasma display apparatus of the present invention includes a plasma display panel, an energy supply and recovery unit 300, a path select controller 310 and a voltage sustain unit 320.

The plasma display panel includes an electrode ELD. At this time, the electrode ELD can be a scan electrode or a sustain electrode.

The energy supply and recovery unit 300 supplies the energy of a first voltage higher than a reference voltage and recovers the energy of a second voltage lower than the reference voltage. At this time, the reference voltage can correspond to 0.5 times a sustain voltage that forms a sustain pulse for sustaining discharging of the plasma display panel. Therefore, the first voltage can be higher than the voltage of 0.5 times the sustain voltage and the second voltage can be lower than the voltage of 0.5 times the sustain voltage.

This energy supply and recovery unit 300 includes a first capacitor Cs1, a second capacitor Cs2 and a third capacitor Cs3. The first capacitor Cs1, the second capacitor Cs2 and the third capacitor Cs3 are connected with one another in series. The first capacitor Cs1 is electrically connected at one end to a source voltage source Vsource. The second capacitor Cs2 is electrically connected to the other end of the first capacitor Cs1. The third capacitor Cs3 is connected at one end to the other end of the second capacitor Cs2.

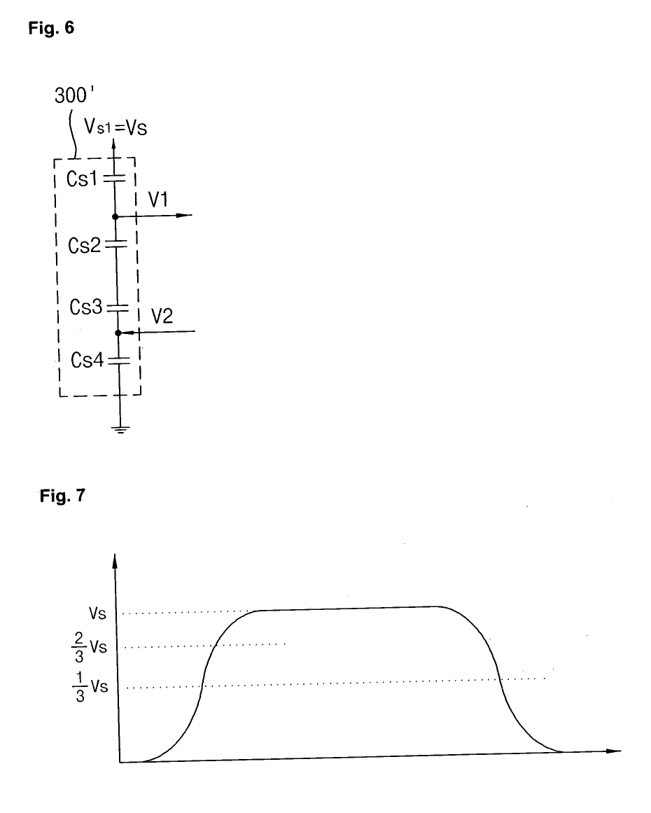

At this time, energy corresponding to a first voltage (V1) is supplied through the connection node of the first capacitor Cs1 and the second capacitor Cs2. Furthermore, energy corresponding to a second voltage (V2) is recovered through a connection node of the second capacitor Cs2 and the third capacitor Cs3. Of course, as shown in FIG. 6, an energy supply and recovery unit 300′ can have three or more capacitors Cs1 to Cs4. That is, the amount of a voltage applied to each of the capacitors constituting the energy supply and recovery unit 300′ is the result of dividing the first voltage source depending on capacitance of each capacitor. Therefore, if the first voltage (V1) of the connection node of the first capacitor Cs1 and the second capacitor Cs2 is higher than the reference voltage and the second voltage (V2) of the connection node of the third capacitor Cs3 and the fourth capacitor Cs4 is lower than the reference voltage, the energy supply and recovery unit 300′ of FIG. 6 and the energy supply and recovery unit 300 of FIG. 5 perform the same operation.

The path select controller 310 supplies the energy of the first voltage, which is received from the energy supply and recovery unit 300, to the electrode ELD through resonance and supplies the energy of the second voltage, which is received from the electrode ELD, to the energy supply and recovery unit 300 through resonance.

This path select controller 310 includes a first switch S1, a second switch S2 and an inductor L. The first switch S1 forms the supply path of energy corresponding to the first voltage (V1) supplied from the energy supply and recovery unit 300. The second switch S2 forms the recovery path of energy corresponding to the second voltage (V2) recovered to the energy supply and recovery unit 300. The inductor L supplies energy corresponding to the first voltage (V1), which is supplied through the first switch S2 that is turned on, to the electrode ELD through resonance and recovers energy corresponding to the second voltage (V2) by the second switch S2 that is turned on.

In the voltage sustain unit 320, the path select controller 300 applies the energy of the first voltage (V1) to the electrode ELD through resonance and then applies the third voltage (V3) to the electrode. The energy supply and recovery unit 300 recovers the energy of the second voltage (V2) from the electrode ELD through resonance and applies the recovered energy to the fourth voltage (V4). At this time, the third voltage (V3) can be the sustain voltage (Vs) and the fourth voltage (V4) can be the voltage of the ground level.

A driving method of the present invention will be described in detail with reference to the remaining drawings.

FIG. 7 shows a driving waveform depending on the driving method of the plasma display apparatus according to a first embodiment of the present invention.

If the first switch S1 is turned on and the remaining switch is turned off, the energy supply and recovery unit 300 supplies energy corresponding to the first voltage (V1) higher than the reference voltage to the electrode ELD through resonance with the inductor L.

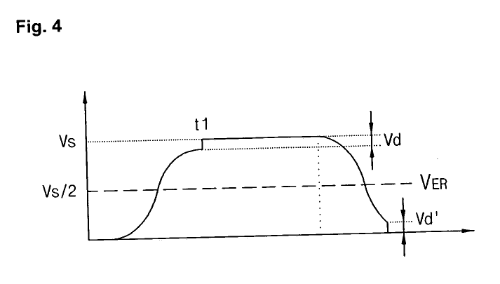

For example, if the capacity of the first capacitor Cs1, the second capacitor Cs2 and the third capacitor Cs3 is the same, a voltage applied to each of the first capacitor Cs1, the second capacitor Cs2 and the third capacitor Cs3 is ⅓ of the voltage applied from the source voltage source Vsource. Therefore, when a voltage supplied by the source voltage source Vsource is the sustain voltage (Vs) and the reference voltage is 0.5 times the sustain voltage (Vs), the first voltage (V1) at the connection node of the first capacitor Cs1 and the second capacitor Cs2 is ⅔ times the sustain voltage (Vs), which is higher than the sustain voltage (Vs) of 0.5 times. As described above, since energy corresponding to the first voltage (V1) higher than the reference voltage is supplied to the electrode ELD through resonance, the voltage of the electrode ELD can sufficiently reach the sustain voltage (Vs). Accordingly, Vd shown in FIG. 4 can be minimized or lost.

Thereafter, as the third switch S3 is turned on, the third voltage (V3=Vs) is applied to the electrode ELD. The voltage of the electrode ELD is thus kept to the third voltage (V3=Vs).

Next, if the second switch S2 is turned on and the remaining switches are turned off, the energy supply and recovery unit 300 supplies energy corresponding to the second voltage (V2) lower than the reference voltage from the electrode ELD through resonance with the inductor L.

For example, if the capacity of the first capacitor Cs1, the second capacitor Cs2 and the third capacitor Cs3 is the same, a voltage applied to each of the first capacitor Cs1, the second capacitor Cs2 and the third capacitor Cs3 is ⅓ of the voltage applied from the source voltage source Vsource. Therefore, when a voltage supplied by the source voltage source Vsource is the sustain voltage (Vs) and the reference voltage is 0.5 times the sustain voltage (Vs), the second voltage (V2) at the connection node of the second capacitor Cs2 and the third capacitor Cs3 is ⅓ times the sustain voltage (Vs), which is lower than the sustain voltage (Vs) of 0.5 times. As described above, since energy corresponding to the second voltage (V2) lower than the reference voltage is recovered from the electrode ELD through resonance, the voltage of the electrode ELD can sufficiently reach the sustain voltage (Vs). Accordingly, Vd′ shown in FIG. 4 can be minimized or lost.

Thereafter, as the fourth switch S4 is turned on, the fourth voltage (V4=Vs) is applied to the electrode ELD. The voltage of the electrode ELD is thus kept to the ground level.

The first embodiment of FIG. 7 corresponds to a case where the capacity of each of the capacitors of the energy supply and recovery unit 300 is the same or a case where the capacity of one or more of three or more capacitors constituting the energy supply and recovery unit 300 is different from that of the remaining capacitors.

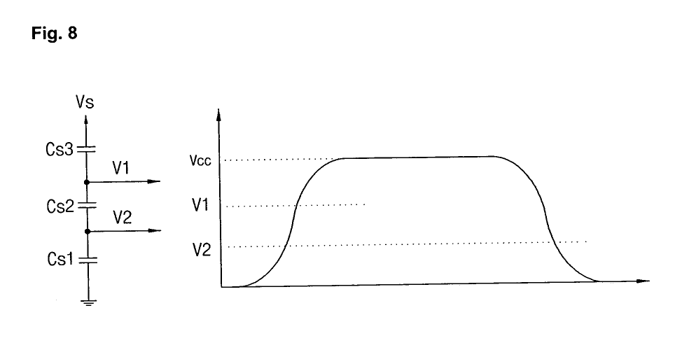

FIG. 8 shows a driving waveform depending on the driving method of the plasma display apparatus according to a second embodiment of the present invention. Referring to FIG. 8, the capacity of one or more of three capacitors Cs1, Cs2 and Cs3 is different from that of the remaining capacitors. For example, the capacity of the second capacitor Cs2 can be greater than that of the remaining capacitor Cs1, Cs3. Even in this case, upon supply of energy, the voltage of the electrode ELD can sufficiently rise up to the sustain voltage (Vs) (i.e., the third voltage). Upon recovery of energy, the voltage of the electrode ELD can sufficiently fall up to the ground level (i.e., the fourth voltage).

As described above, according to the present invention, the energy supply and recovery unit supplies energy greater than the reference voltage and recovers energy lower than the reference voltage. Accordingly, driving efficiency can be improved.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A plasma display apparatus, comprising:
a plasma display panel having an electrode;
an energy supply and recovery unit for dividing a source voltage source to supply the energy of a first voltage higher than a reference voltage and to supply the energy of a second voltage lower than the reference voltage;
a path select controller for establishing a path so that the energy of the first voltage is supplied to the electrode through resonance and establishing a path so that the energy of the second voltage is recovered from the electrode through resonance; and
a voltage sustain unit for applying a third voltage to the electrode after the energy of the first voltage has been supplied to the electrode through resonance and applying a fourth voltage to the electrode after the energy of the second voltage is been recovered from the electrode through resonance.

2. The plasma display apparatus as claimed in claim 1, wherein the energy supply and recovery unit comprises three or more capacitors connected with one another in series, for dividing the source voltage source to form the first voltage and the second voltage.

3. The plasma display apparatus as claimed in claim 1, wherein the energy supply and recovery unit comprises a first capacitor, a second capacitor and a third capacitor that are connected with one another in series,
the first capacitor is connected at one end to the source voltage source, the second capacitor is connected at one end to the other end of the first capacitor, and the third capacitor is connected at one end to the other end of the second capacitor, and
the first voltage is formed at the connection node of the first capacitor and the second capacitor, and the second voltage is formed at the connection node of the second capacitor and the third capacitor.

4. The plasma display apparatus as claimed in claim 2, wherein each of the three or more capacitors has the same capacitance.

5. The plasma display apparatus as claimed in claim 1, wherein the reference voltage is a voltage corresponding to 0.5 times the third voltage.

6. The plasma display apparatus as claimed in claim 1, wherein a voltage of the source voltage source and the third voltage are the same.

7. The plasma display apparatus as claimed in claim 1, wherein the fourth voltage is a voltage of the ground level.

8. The plasma display apparatus as claimed in claim 1, wherein the path select controller comprises a first switch for forming the supply path of energy corresponding to the first voltage, a second switch for forming the supply path of energy corresponding to the second voltage, and an inductor for supplying energy corresponding to the first voltage, which is applied through the first switch that is turned on, to the electrode through resonance and recovering energy corresponding to the second voltage from the second switch that is turned on by way of resonance.

9. A plasma display apparatus, comprising:
an energy supply and recovery unit including three or more capacitors connected with one another in series, for dividing a source voltage source, wherein the energy supply and recovery unit supplies the energy of a first voltage higher than a reference voltage and recovers the energy of a second voltage lower than the reference voltage;
a path select controller for establishing a path so that the energy of the first voltage is supplied to the electrode through resonance and establishing a path so that the energy of the second voltage is recovered from the electrode through resonance; and
a voltage sustain unit for applying a third voltage to the electrode after the energy of the first voltage has been supplied to the electrode through resonance and applying a fourth voltage to the electrode after the energy of the second voltage has been recovered from the electrode through resonance.

10. The plasma display apparatus as claimed in claim 9, wherein the energy supply and recovery unit comprises three or more capacitors connected with one another in series, for dividing the source voltage source to form the first voltage and the second voltage.

11. The plasma display apparatus as claimed in claim 9, wherein the energy supply and recovery unit comprises a first capacitor, a second capacitor and a third capacitor that are connected with one another in series,
the first capacitor is connected at one end to the source voltage source, the second capacitor is connected at one end to the other end of the first capacitor, and the third capacitor is connected at one end to the other end of the second capacitor, and
the first voltage is formed at the connection node of the first capacitor and the second capacitor, and the second voltage is formed at the connection node of the second capacitor and the third capacitor.

12. The plasma display apparatus as claimed in claim 9, wherein each of the three or more capacitors has the same capacitance.

13. The plasma display apparatus as claimed in claim 9, wherein the reference voltage is a voltage corresponding to 0.5 times the third voltage.

14. The plasma display apparatus as claimed in claim 9, wherein a voltage of the source voltage source and the third voltage are the same.

15. The plasma display apparatus as claimed in claim 9, wherein the fourth voltage is a voltage of the ground level.

16. A driving method of a plasma display panel including an electrode, comprising the steps of:
supplying the energy of a first voltage higher than a reference voltage to the electrode through resonance;
applying a third voltage to the electrode;
recovering the energy of the second voltage lower than the reference voltage from the electrode to the energy supply and recovery unit through resonance; and
applying a fourth voltage to the electrode.

17. The driving method as claimed in claim 16, wherein the reference voltage is a voltage corresponding to 0.5 times the third voltage.

18. The driving method as claimed in claim 16, wherein a voltage of the source voltage source and the third voltage are the same.

19. The driving method as claimed in claim 16, wherein the fourth voltage is a voltage of the ground level.
